(19) United States
(12) Patent Application Publication
(10) Pub. No.: US 2007/0018064 A1
(43) Pub. Date: Jan. 25, 2007

(54) Holder

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/184,908

(22) Filed: Jul. 20, 2005

(51) Int. Cl. F16B 47/00; B60R 7/00; A47F 5/00

(52) U.S. Cl. 248/274.1; 248/309.1; 248/206.2; 248/311.2; 224/929; 224/42.32; 224/559

(57) ABSTRACT

The present invention is to provide a holder, which comprises a flexible arm having one end connected to the top of a seat, an adjustment member rotatably provided at the other end of the flexible arm, and a connection member and a support connected to the other end of the flexible arm above the adjustment member sequentially, wherein bottom of the support contacts the connection member, top of the support is adapted to support and fasten an electronic device, and the adjustment member is adapted to move either toward the connection member for gradually tightly engaging the connection member and the support together and prohibiting the support from rotating, or away from the connection member for gradually loosening the connection member and the support and enabling the support to rotate relative to the connection member.

### FIELD OF THE INVENTION

The present invention relates to holders and more particularly to such a holder having an improved fastening means for securely adhering the holder having a portable electronic device mounted thereon to, for example, a dashboard of motor vehicle.

### BACKGROUND OF THE INVENTION

The world has entered into a new era with technology being progressed rapidly. For example, the availability of a great variety of advanced electronic products not only brings a lot of convenience but also is closely associated with our daily life and work. Portable electronic devices are among the important ones of the electronic products. A well known one of the portable electronic devices is a PDA (personal digital assistant) or a mobile phone. The portable electronic devices have advantages of being compact, lightweight, and capable of incorporating one or more features including memorandum, schedule, database, video game, phonebook, English-Chinese dictionary, graphics, and calculator. Also, the sale of portable electronic devices is increased significantly in recent years due to its popularity among vast consumers. In response, many manufacturers concentrate their research and development in the portable electronic devices in order to not only make the existing benefits (e.g., compactness, slimness, and lightweight) more advantageous but also incorporate more advanced features.

Conventionally, a portable electronic device, used as a personal management assistant, video game machine, music player, or navigation system, is, for example, fastened in a suitable place inside a vehicle. Thus, a driver may easily conveniently use the portable electronic device while driving. Such fastening is typically carried out by the provision of a holder in a motor vehicle in which the portable electronic device is mounted on the holder. In use, a person in a car may adjust an angle of the holder so as to conveniently view or use a portable electronic device mounted on the holder while driving.

A conventional holder 10 mounted in a motor vehicle is shown in FIG. 1 and comprises a flexible arm 11 in the form of coil, a retaining member 12 provided at one end of the arm 11, a suction cup 13 provided at one end of the retaining member 12 distal the arm 11, the suction cup 13 adapted to adhere to a surface, for example, a dashboard of car, and a cradle 14 provided at the other end of the arm 11, the cradle 14 including a board 140, a fastening means 141, a hollow bar 142, a pin 143, a lever 144, and an indentation 145. A top surface of the board 140 distal the arm 11 is adapted to support and fasten a portable electronic device. The fastening means 141 is adapted to drive through the board 140 into the bore of the hollow bar 142 for fastening. The hollow bar 142 is provided at the other end of the arm 11. A transverse hole is formed at one end of the hollow bar 142 distal the fastening means 141. The pin 143 is adapted to insert through the arm 11, the transverse hole, and the lever 144 for pivotably connecting the lever 144 to the hollow bar 142. The indentation 145 is formed on a top face of the board 140 facing the cradle 14. Thus, the board 140 is mounted between the fastening means 141 and the indentation 145.

By configuring as above, in use a user may pivot the lever 144 about the pin 143 toward the board 140 to move the hollow bar 142 toward the arm 11. Thus, the board 140 is fastened between the fastening means 141 and the indentation 145 (i.e., the board 140 is prohibited from being adjusted). To the contrary, pivoting the lever 144 about the pin 143 toward the arm 11 will loosen the board 140 (i.e., the board 140 is permitted to adjust). Thus, a person in a car may adjust an angle of the cradle 14 so as to adjust an electronic device mounted thereon to an optimum operating angle while driving.

However, a user cannot adjust the board 140 when the board 140 is fastened between the fastening means 141 and the indentation 145. Further, the board 140 is suddenly loosened due to no clamping by the fastening means 141 and the indentation 145 in response to pivoting the lever 144 about the pin 143 toward the arm 11. Furthermore, after operating the cradle 14 for a period of time pivoting the lever 144 about the pin 143 toward the board 140 will not fasten the board 140 between the fastening means 141 and the indentation 145 due to vibration of motor vehicle or loosening of the hollow bar 142 fastened by the fastening means 141. Thus, the function of adjusting location and angle of the board 140 by the conventional holder 10 for motor vehicle is compromised. Thus, it is desirable to provide a novel holder in order to overcome the inadequacy of the prior art.

### SUMMARY OF THE INVENTION

After considerable research and experimentation, a holder according to the present invention has been devised so as to overcome the above drawback of the prior art.

It is an object of the present invention to provide a holder comprising a seat, a flexible arm, an adjustment member, a connection member, and a support. An adhering member is provided in a bottom of the seat for fastening the holder at a supporting surface. Top of the seat is connected to one end of the flexible arm. The adjustment member is rotatably provided at the other end of the arm proximate the connection member. The other end of the arm is connected to the connection member and the support sequentially. Bottom of the support contacts the connection member and the support thus can rotate relative to the connection member. Top of the support is adapted to support and fasten an electronic device. The adjustment member is adapted to move either toward the connection member for gradually tightly engaging the connection member and the support together and for fixing and prohibiting the support from rotating, or away from the connection member for gradually loosening the connection member and the support and for enabling the support to rotate relative to the connection member again.

The above and other objects, features and advantages of the present invention will become apparent from the following detailed description taken with the accompanying drawings.

### BRIEF DESCRIPTION OF THE DRAWINGS

FIG. 1 is an exploded view of a conventional holder;

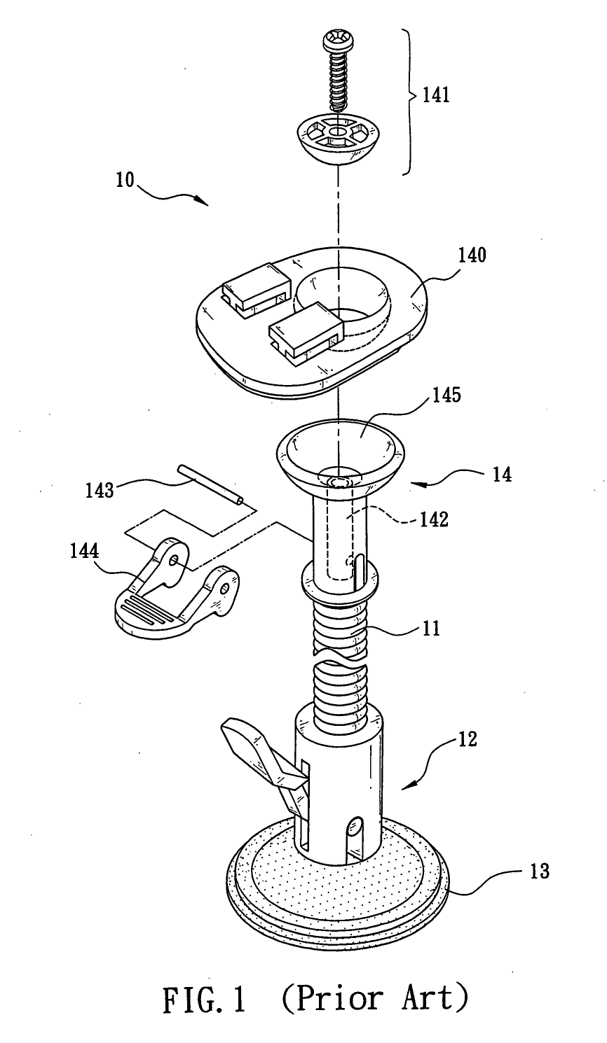

FIG. 2 is a perspective view of a preferred embodiment of holder according to the invention;

FIG. 3 is an exploded view of the holder shown in FIG. 2; and

FIG. 4 is a side view in part section of upper portion of the holder shown in FIG. 2 where a friction sheet is sandwiched between the connection member and the support.

### DETAILED DESCRIPTION OF THE PREFERRED EMBODIMENTS

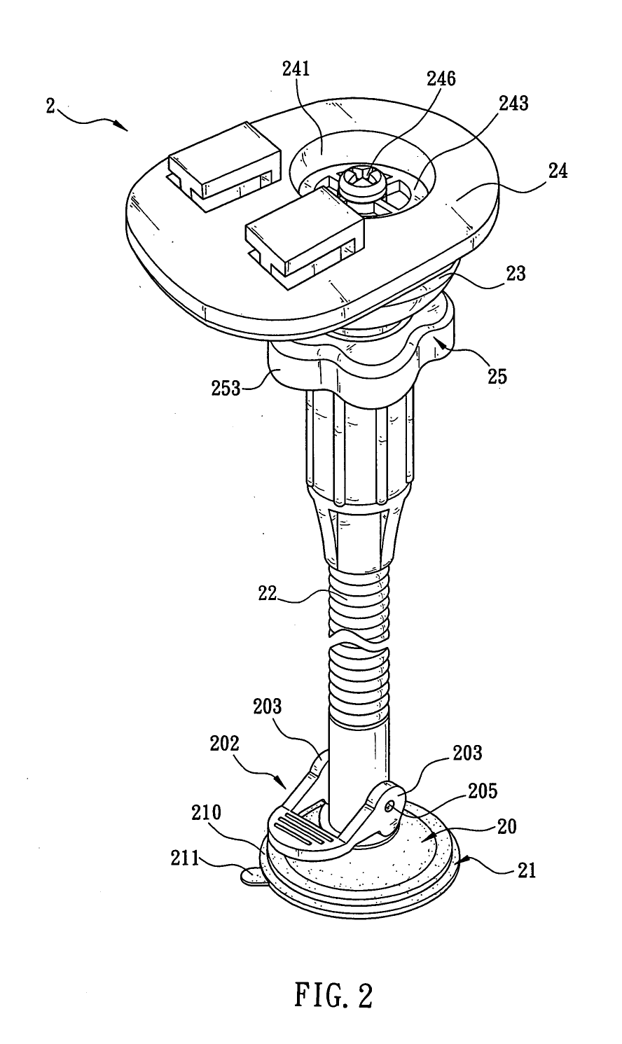

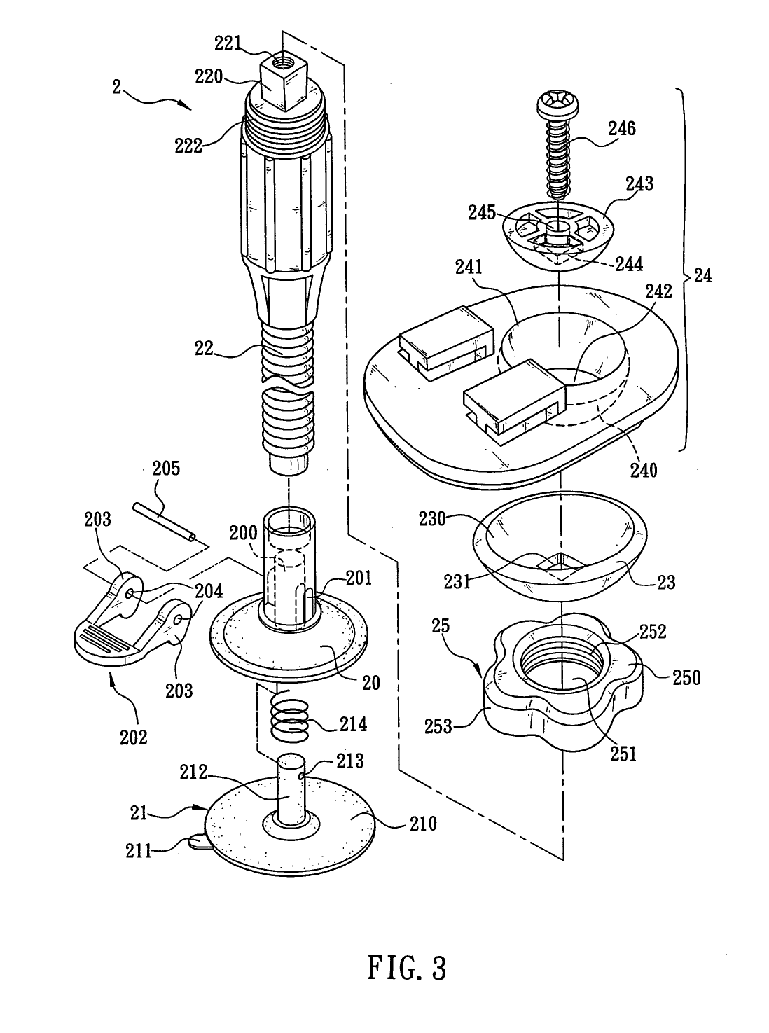

Referring to FIGS. 2 and 3, a holder 2 in accordance with the invention comprises a disc-shaped seat 20 including an adhering member 21 provided in its bottom for fastening the holder 2 at a supporting surface. Top of the seat 20 is connected to one end of a flexible arm 22 in the form of coil. The other end of the arm 22 is connected to a connection member 23 and a support 24 sequentially. Bottom of the support 24 contacts the connection member 23 and the support 24 thus can rotate relative to the connection member 23. Top of the support 24 is adapted to support and fasten an electronic device (e.g., PDA). A rotatable adjustment member 25 is provided at the other end of the arm 22 proximate the connection member 23. The adjustment member 25 is adapted to move toward the connection member 23 for fastening both the connection member 23 and the support 24. Thus, the support 24 is fixed and is prohibited from rotating. To the contrary, both the connection member 23 and the support 24 are loosened gradually when the adjustment member 25 moves away from the connection member 23. This can prevent the support 24 from rotating due to loosening.

Referring to FIG. 3 specifically, in a preferred embodiment of the invention an indentation 230 is formed on top of the connection member 23 facing the support 24. A projection 240 is formed on an underside of the support 24. The projection 240 is pivotably provided in the indentation 230. Thus, the support 24 is adapted to swing as a universal joint in the indentation 230 for adjusting location and angle of the support 24. A square opening 231 is formed on a center of the connection member 23. The opening 231 is adapted to put on a protrusion 220 of square section on the other end of the arm 22 so as to sleeve the connection member 23 on the protrusion 220 and slide along the protrusion 220.

Referring to FIG. 3 again, in the embodiment the support 24 further comprises a cavity 241, a tunnel 242, a fastening member 243, and a fastener 246. The cavity 241 is provided in the projection 240. The tunnel 242 is through the projection 240 and the cavity 241. The fastening member 243 is shaped to pivot in the cavity 241. A recessed portion 244 is formed on an underside of the fastening member 243 facing the cavity 241. The recessed portion 244 is adapted to put on the protrusion 220. A threaded hole 245 is formed and extended from the recessed portion 244 through the center of the fastening member 243 to expose on top of the fastening member 243. the fastener (e.g., screw) 246 is driven through the threaded hole 245, the recessed portion 244, and the projection 240 into the opening 231 (i.e., threadedly secured to an inner threaded hole 221 exposed to top of the protrusion 220). Thus, the fastening member 243 is secured to top of the protrusion 220. As a result, the connection member 23 and the support 24 are movably disposed between the protrusion 220 and the fastening member 243.

Referring to FIG. 3 again, in the embodiment the ring-shaped adjustment member 25 comprises a body 250, a through hole 251 through the body 250, a threaded section 252 around an inner surface of the through hole 251, the threaded section 252 adapted to threadedly secure to an outer threaded section 222 below the protrusion 220 and above the other end of the arm 22, and a plurality of arcuate protuberances 253 around the body 250, the protuberances 253 adapted to facilitate turning of the adjustment member 25 by the hand. In response to turning the adjustment member 25 toward the connection member 23, the connection member 23 is pushed by the adjustment member 25 such that the connection member 23 and the support 24 are gradually tightly engaged together. To the contrary, turning the adjustment member 25 away from the connection member 23 will gradually loosen the connection member 23 and the support 24.

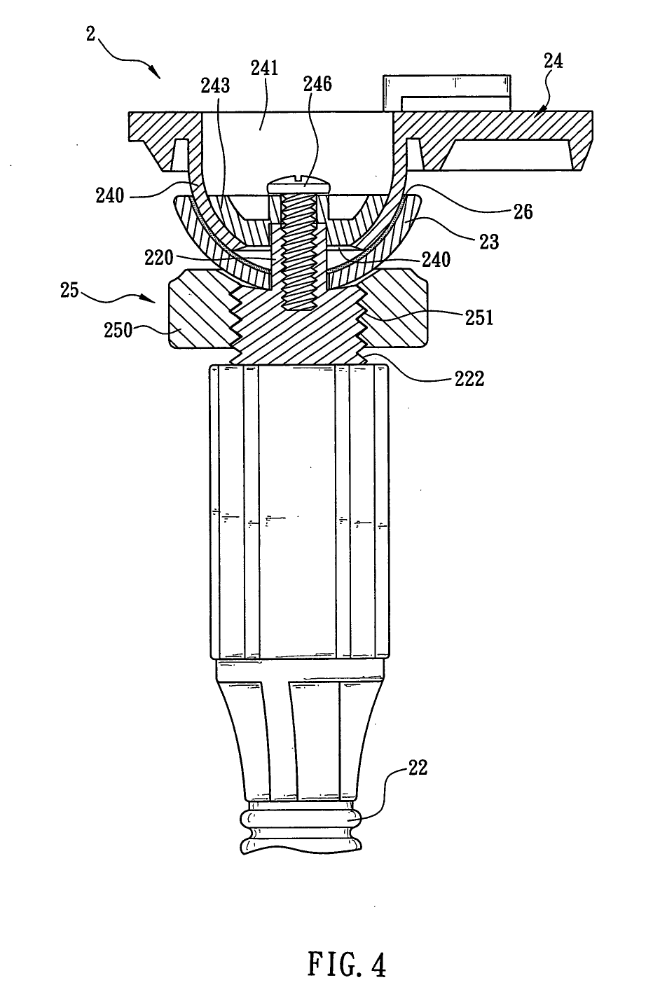

Referring to FIG. 4, in the embodiment a friction sheet 26 is sandwiched between the connection member 23 and the support 24. The friction sheet 26 has a central opening for permitting the fastener 246 to pass the friction sheet 26. Friction between the connection member 23 and the support 24 can be decreased by the provision of the friction sheet 26. Thus, a user may finely adjust the support 24. Also, the support 24 is adapted to stay at the adjusted angle without sliding.

Referring to FIG. 3 again, in the embodiment the arm 22 is implemented as a coil and is adapted to flex arbitrarily. Thus, it is possible of adjusting the electronic device mounted on the holder 2 toward any desired angle by means of the arm 22 and the support 24.

Referring to FIG. 3 again, in the embodiment the adhering member 21 comprises a suction cup 210, a finger tab 211, a post 212, a through hole 213, and an elastic member (e.g., spring) 214. The suction cup 210 is formed on a bottom of the seat 20 for adhering the holder 2 to a surface (e.g., dashboard of a motor vehicle or top of a desk). The finger tab 211 is projected from a periphery of the suction cup 210. In response to pushing the finger tab 211 away from the supporting surface a gap is formed between the suction cup 210 and the supporting surface. Thus, a user may detach the holder 2 from the supporting surface. The post 212 is formed on a center of the suction cup 210 and a top of the post 212 is extended away therefrom. The elastic member 214 is put on the post 212 in which one end of the elastic member 214 is biased against top of the suction cup 210 and the other end thereof is biased against bottom of the seat 20. The through hole 213 transversely passes an upper portion of the post 212 proximate the other end thereof. As such, the post 212 is adapted to slidably dispose in the seat 20.

Referring to FIG. 3 again, in the embodiment the seat 20 further comprises a hollow cylinder 200, a lever 202, and a pin 205. Lower end of the hollow cylinder 200 is terminated at top of the seat 20 and upper end thereof is extended a predetermined distance away from the adhering member 21. The hollow cylinder 200 is adapted to receive the post 212. The hollow cylinder 200 comprises a transverse channel 201 in its lower portion aligned with two opposite points of an inner surface of the through hole 251. A user may grasp an outer end of the lever 202. A latch 203 is projected from a lower portion of either branch of a bifurcation of the lever 202 and a through hole 204 is formed at an upper portion of either branch of the bifurcation of the lever 202. The pin 205 is adapted to insert through the through holes 204, the channel 201, the through hole 213 to connect the post 212, the seat 20, and the lever 202 together.

By configuring as above, pivoting the lever 202 about the pin 205 toward the suction cup 210 will lift the other end of the post 212 away from the hollow cylinder 200 due to expansion of the elastic member 214. A gap is thus formed between the seat 20 and the suction cup 210. The pin 205 in the channel 201 moves away from the suction cup 210 and the post 212 thus moves into the bore of the hollow cylinder 200 in response to pivoting the lever 202 toward the suction cup 210. Bottom of the seat 20 is thus urged against top of the suction cup 210. Also, central portion of the suction cup 210 facing the hollow cylinder 200 is partially deformed. Thus, the suction cup 210 contacts the supporting surface when the seat 20 is placed on the supporting surface. A suction force is thus created between the suction cup 210 and the supporting surface by pivoting the lever 202. As an end, the seat 20 is strongly adhered to the supporting surface and is not susceptible to sliding or being removed.

While the invention herein disclosed has been described by means of specific embodiments, numerous modifications and variations could be made thereto by those skilled in the art without departing from the scope and spirit of the invention set forth in the claims.

What is claimed is:

1. A holder comprising:
a seat including an adhering member provided in its bottom;
a flexible arm having one end connected to a top of the seat;
a connection member removably connected to the other end of the arm;
a support connected to the other end of the arm, the support having its bottom to be in contact the connection member such that the support is adapted to rotate relative to the connection member, and its top adapted to support and fasten an electronic device; and
an adjustment member rotatably provided at the other end of the arm proximate the connection member, the adjustment member being adapted to move either toward the connection member for gradually tightly engaging the connection member and the support together or away from the connection member for gradually loosening the connection member and the support.

2. The holder of claim 1, further comprising a projection formed on an underside of the support, a protrusion formed on the other end of the arm, and an indentation formed on a top of the connection member facing the support wherein the projection is pivotably provided in the indentation for permitting the support to swing in the indentation, and the connection member further comprises a central opening, the central opening being adapted to matingly put on the protrusion for sleeving the connection member on the protrusion and sliding the connection member along the protrusion.

3. The holder of claim 2, wherein the support further comprises:
a cavity provided in the projection;
a tunnel passed through the projection and the cavity;
a fastening member adapted to pivot in the cavity, the fastening member including a recessed portion formed on its underside facing the cavity, the recessed portion being adapted to put on the protrusion, a first threaded hole formed and extended from the recessed portion through the fastening member to expose on a top of the fastening member; and
a fastener driven through the first threaded hole, the recessed portion, and the projection into the central opening to threadedly secure to a second threaded hole extended from a top of the protrusion into the protrusion such that the fastening member is secured to the top of the protrusion, and the connection member and the support are movably disposed between the protrusion and the fastening member.

4. The holder of claim 3, wherein the adjustment member comprises a ring-shaped body, a third through hole formed through the body, a threaded section formed around an inner surface of the third through hole, the threaded section adapted to threadedly secure to outer threads formed below the protrusion and above the other end of the arm, and a plurality of arcuate protuberances formed around the body.

5. The holder of claim 2, further comprising a friction sheet sandwiched between the connection member and the support, the friction sheet including an opening for permitting the fastener to pass the friction sheet.

6. The holder of claim 1, wherein the arm is shaped as a coil and is adapted to flex toward one of a plurality of directions.

7. The holder of claim 1, wherein the adhering member comprises:
a suction cup formed on a bottom of the seat for adhering the holder a supporting surface;
a finger tab projected from a periphery of the suction cup;
a post formed on a center of the suction cup, the post having a bottom within the suction cup and a top extended away therefrom; and
a fourth through hole transversely passed the post proximate its top.

8. The holder of claim 7, wherein the seat further comprises:
a hollow cylinder having a lower end terminated at the top of the seat and an upper end extended a predetermined distance away from the adhering member, the hollow cylinder being adapted to receive the post, the hollow cylinder including a transverse channel in its lower portion aligned with two opposite points of an inner surface of the third through hole;
a bifurcated lever including an outer portion to be grasped by a hand, a latch projected from a lower portion of either branch of the bifurcation, and a fifth through hole formed at an upper portion of either branch of the bifurcation, the fifth through holes being aligned with the channel; and
a pin inserted through the fifth through holes, the channel, the fourth through hole to connect the post, the seat, and the lever together.

9. The holder of claim 7, further comprising an elastic member put on the post, the elastic member having one end biased against a top of the suction cup and the other end biased against the bottom of the seat.
